(19) United States
(12) Patent Application Publication
(10) Pub. No.: US 2008/0267791 A1
(43) Pub. Date: Oct. 30, 2008

(54) System for the Suction of a Fluid, Having the Additional Function of Sucking Another Fluid

(76) Inventors: Leonardo Cadeddu, Crema (IT); Christian Jezek, Cognola (IT)

Correspondence Address: YOUNG & THOMPSON, 209 Madison Street, Suite 500, ALEXANDRIA, VA, 22314, US

(21) Appl. No.: 10/594,523

(22) PCT Filed: Mar. 17, 2005
(86) PCT No.: PCT/EP2005/002979

§ 371 Date: Sep. 28, 2006

(30) Foreign Application Priority Data
Mar. 29, 2004 (IT) TO2004A000206

(51) Int. Cl. F04B 49/04; B60T 13/24

(52) U.S. Cl. 417/211.5; 417/65; 303/12

(57) ABSTRACT

A suction system comprising a suction pump (1) having at least one suction connection (2,2′,2″) and a delivery connection (3), a receiving reservoir (4) connected to the delivery connection (3), connecting pipings from a suction connection (2,2′) to a first space (7) from which a first fluid (8) should be sucked, and connecting pipings from the delivery connection (3) to the receiving reservoir (4), characterized in that the system further comprises a connecting piping (14,15,16) extending from a second space (10), from which a second fluid (11) should be sucked, to a suction connection (2,2″) of the pump (1), and comprises a device (12) disposed for causing an intermittent operation of the second fluid suction by the pump (1), responsive to the level reached by the second fluid (11) in the second space (10). Preferably, the pump (1) is a vacuum pump, the first fluid (8) is air, the first space (7) is a depressurized reservoir, the second fluid (11) is oil and the second space (10) is a space wherein oil (11) has a tendency to accumulate. The system is especially, but not exclusively, intended for automotive applications.

### BACKGROUND OF THE INVENTION

The subject of the present invention is a system for the suction of a fluid, this system having the additional function of sucking another fluid.

Such a system is particularly suitable for embodying an air suction system which is capable of additionally sucking oil, and is especially suitable for automotive applications; therefore this invention will be particularly described, by way of example, with reference to said application, being however to be understood that this invention may find possible applications in other fields, in order to suck various kinds of fluids.

In the automotive field are used air suction pumps, the so called “vacuum pumps”, whose function is to produce in a special reservoir a depression, the so called “vacuum”, which is used by the servobrake devices (Brake Booster) which pneumatically operate in order to amplify the force applied by the driver to the brake pedal for the activation of the vehicle braking system.

The same vacuum pump can also perform the same function of producing an air depression in a reservoir for different purposes, by providing a depression to auxiliary components of the vehicle and/or of the engine which need such depression for their operation, such as vibration absorbers, air delivery modulators and, in general, all the pneumatical devices that need a depression for their operation. These functions may take place either through a single suction connection of the pump, or through two separate suction connections.

The vacuum pump is driven by a mechanical connection to a moving shaft of an internal combustion engine or to a shaft driven by an electric motor. The pump generates a depression Inside a reservoir by extracting air therefrom through an airtight connection between said reservoir and the suction connection of the pump, and the air that it discharges is mixed with the lubricating oil of the pump itself. The oil present in the suction pump also have the function of a fluid packing, in order to optimize the pneumatic sealing of the functional clearances of the moving pump members. The discharge is done by the pump through a delivery connection towards another space, which can be another reservoir or a space of the vehicle engine, such as the sump. The vacuum pump performs in this case the function of transferring the air from a first reservoir to a second reservoir, thus generating a depression in the first reservoir. The air contained in the air-and-oil mixture delivered by the pump is then separated by action of special oil separating devices within the engine or the reservoir that receives the mixture, and then it is discharged in the ambient. Therefore, the pump has at least one suction connection intended to be connected to the first reservoir, and a delivery connection intended to be connected to the second reservoir, and inside the pump rotates a mechanism comprising a rotor coupled to at least one blade which, during the rotation, transfers the air from the suction connection to the delivery connection.

Moreover, in certain cases the problem may arise to suck oil from a space wherein it has the tendency to accumulate, and to transfer the oil in another oil tank. In this case an oil suction pump should be installed. Such pump becomes necessary in those cases in which the space from which the oil is to be removed is situated, or even in certain circumstances may come to be situated, at a level lower that the level of the tank to which the oil should be forwarded, whereby it is not possible to have recourse, as in other cases, to the action of the gravity. Therefore, in such cases two separate suction pumps are to be installed, one pump being intended to suck the air and the other pump being intended to suck the oil.

With reference to the automotive applications, an object of the present invention resides in simplifying such a double suction system in order to reduce the cost, the encumbrance and the energy absorption. Moreover, with similar purposes, the invention may find applications in any field of the techniques wherein similar requirements arise, with reference to any kind of fluids.

### SUMMARY OF THE INVENTION

This invention is based on the principle of allotting to the pump, which is intended to suck the first fluid from a first space, also an intermittent function of sucking a second fluid from a second space, with the purpose of transferring this second fluid in another space by taking advantage of the capability of the pump to suck fluids through its suction connections when the pump is activated. In the case of an automotive application, in general the task is to transfer oil from a space wherein it has the tendency to accumulate, to the sump of the internal combustion engine.

To this aim, the invention proposes a suction system comprising a suction pump having at least one suction connection and a delivery connection, a receiving reservoir connected to said delivery connection, connecting pipings from said at least one suction connection to a first space from which a first fluid should be sucked, and connecting pipings from said delivery connection to said receiving reservoir, characterized in that the system further comprises a connecting piping from a second space, from which a second fluid should be sucked, to said at least one suction connection of the pump, and comprises a device disposed for causing an intermittent operation of the second fluid suction by the pump, responsive to the level reached by a fluid in said second space.

In this way, the installation is simplified in that the use of a single pump is sufficient for both the functions of sucking the first fluid from the first space and of intermittently sucking the second fluid from the second space. Therefore the cost and the encumbrance of the installation are reduced, and also the energy absorption of the system is reduced, because the energy absorption of the sole pump having two functions is smaller than the energy absorption of two independent pumps.

Preferably, for the automotive applications, said pump is a vacuum pump, said first fluid is air, said first space is a depressurized reservoir, said second fluid is oil and said second space is a space wherein oil has a tendency to accumulate.

In this manner the vacuum pump, which is always installed for the above mentioned purposes, is also used for effecting the function of transferring to the engine sump the oil which has the tendency to accumulate in the second space, and this function is effected without causing any unnecessary or detrimental suction of air from the second space.

Preferably, the pump being a part of the system is of the kind having two suction connections, a first suction connection of the pump is connected to said first space for sucking therefrom said first fluid, and the second suction connection of the pump is connected to said second space for sucking therefrom said second fluid.

In this way, the two suction functions are effected through two different suction connections, and this allows to effectively separate two independent suction circuits and also, when this is considered suitable, to introduce the two fluids, sucked through the two separate connections, to different positions and/or along different directions inside the suction pump.

Preferably, said device disposed for causing an intermittent operation of the pump in sucking said second fluid responsive to the level reached by a fluid in said second space comprises a means for measuring the level reached by said second fluid in said second space, an interception means interposed in said connection from said second space to said at least one suction connection of the pump, and means for activating said interception means when said level of the second fluid comes down a pre-established minimum level, and for inactivating said interception means when said level of the second fluid overcomes a pre-established maximum level.

In this way, the additional function of the suction pump is activated only in the periods of time in which it is of use, and it is inactivated when this additional function would be unnecessary or even detrimental. More particularly, in the case of the removal of oil accumulated in the second space, it is avoided that the pump continuously sucks air from the second space when about all the oil accumulated therein has been sucked.

In a possible embodiment of the invention, said connection from said second space to said at least one suction connection of the pump opens near the bottom of said second space, and inside said second space, in the bottom portion thereof, is installed a device provided with a float, which closes the opening of said connection, thus intercepting the suction of the second fluid by the pump, when the float, along with the second fluid, reaches the pre-established minimum level.

Said connection can arrive to its opening near the bottom of said second space either coming from below or coming from the above and plunging into said second space.

As an alternative to the use of a float, said means for measuring the level reached by said second fluid in said second space may comprise means for revealing the level of said second fluid, installed in said second space at different levels, said interception means is interposed in said connection outside said second space, and said means for activating and inactivating said interception means are controlled by said means for revealing the level of said second fluid.

More particularly, said interception means may advantageously be embodied by an electromagnetically controlled valve (electrovalve), intended for intermittently opening the passageway from said second space to said pump.

### DETAILED DESCRIPTION OF THE DRAWINGS

These and other features, objects and advantages of the subject of the present invention will more clearly appear from the following description of some embodiments, having the character of non-limiting examples, with reference to the appended drawings, wherein:

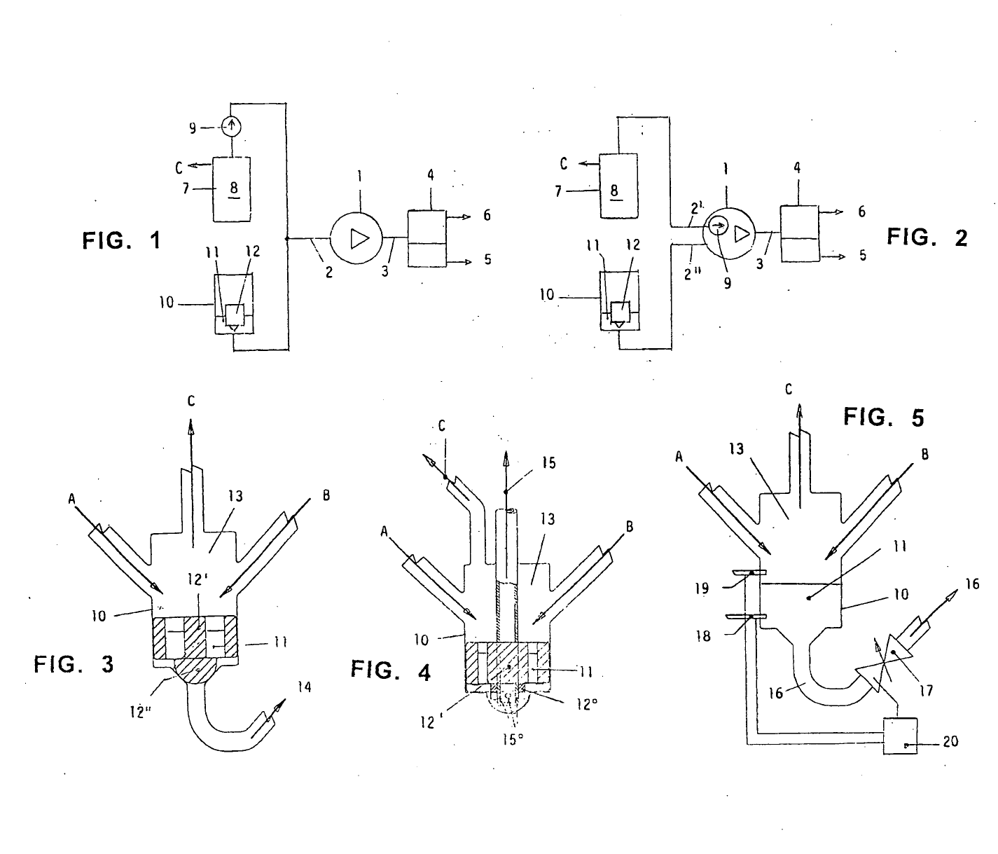

FIG. 1 shows a general diagram of the suction system according to this invention.

FIG. 2 shows a particularly preferred modification of the diagram according to FIG. 1.

FIG. 3 shows a first embodiment of the device intended for causing an intermittent operation of the suction of said second fluid by the pump.

FIG. 4 shows a second embodiment of the device intended for causing an intermittent operation of the suction of said second fluid by the pump.

FIG. 5 shows a third embodiment of the device intended for causing an intermittent operation of the suction of said second fluid by the pump.

### DETAILED DESCRIPTION OF THE PREFERRED EMBODIMENTS

With reference to the general diagram of FIG. 1, reference 1 designates a suction pump provided with at least one suction connection 2 and a delivery connection 3 opening in a collecting tank 4. This latter, in the frequent cases in which the suction operates on different fluids which can be separated by decantation, operates as a decantation means. To this tank 4 are connected a drain tube 5 departing from the bottom region of the collection tank 4 and a vent tube 6 departing from the top region thereof.

The suction connection 2 of the suction pump 1 is connected to a first space 7 from which a first contained fluid 8 is to be sucked; this suction takes place, in certain cases, through a non-return valve 9, and it is the usual function of the suction pump 1. Moreover, according to this invention, the suction connection 2 of the suction pump 1 is additionally connected to a second space 10, from which a second contained fluid 11 is to be sucked. The system further comprises a device 12 disposed for causing an intermittent operation of the suction of said second fluid 11 by the pump 1, responsive to the level reached by a fluid in said second space 10.

When the diagram of FIG. 1 is related to the preferred automotive application of this invention, the suction pump 1 is a vacuum pump, the collection tank 4 is an oil separating device, the first space 7 is a depression reservoir which serves pneumatic appliances and in particular a pneumatic servobrake device, the first fluid 8 is air, and the second space 10 is a space in whose bottom portion the oil 11 has a tendency to accumulate and should be removed, whereas in the upper portion of this second space is contained air, which in general has a pressure near the atmospheric pressure. The suction pump 1 is permanently connected to the depression reservoir 7 used by the servobrake, and it sucks air therefrom when the suction is needed in order to maintain in the reservoir the prescribed depression.

The preferred diagram according to FIG. 2 differs from the diagram of FIG. 1 only in the following. Whilst according to the diagram of FIG. 1 the suction pump 1 has a single suction connection 2, which is subdivided in two branches opening in the first space 7 and respectively in the second space 10, on the contrary, according to the diagram of FIG. 2 the suction pump 1 has two separate suction connections 2′ and 2″, one of which opens in the first space 7 and the other opens in the second space 10.

This second diagram is preferred, on one hand, because it allows completely separating the suction circuit of the first space 7 and the suction circuit of the second space 10, and on the other hand because it allows directing the two sucked fluids 8 and 11 to different positions and along different directions to the inner mechanisms of the suction pump 1, in those cases in which this is considered suitable. Moreover, in this case, the non-return valve 9 can be mounted inside the suction pump 1, as it is done in several known embodiments of the suction pump 1.

In general, the additional function of sucking the fluid 11 from the space 10 should be intermittent in order that it does not disturb the usual function of the suction pump 1, namely the function of sucking the first fluid 8 from the first space 7. In effect, this usual function could be disturbed if an air suction from the second space could take place when the second fluid has been entirely removed by the pump. The suction capability of the pump should be larger than the rate of the arrival of the second fluid in the second space, and it is not possible to foresee the variation of this rate of arrival, and also the rate of arrival of the air accompanying the second fluid. For this reason the pump should remove only the quantity of the second fluid required in order to prevent its accumulation. Therefore the connection between the pump and the second space should be intercepted when the level of the second fluid lowers below a minimum level, whereby the operation of the pump with reference to the second space is rendered intermittent. To this aim operates the device 12, which acts responsive to the level reached by a fluid in said second space 10. In most cases, but not necessarily, the fluid whose level controls the operation of the device 12 is the same fluid 10 which should be removed from the space 10.

The device 12 may assume different configurations, some of which are represented in FIGS. 3 to 5.

According to FIG. 3, the space 10 has inlets A and B through which arrives the second fluid 11, which may be mixed with another fluid intended to escape through a vent C. For example, the second fluid can be oil 11 that arrives to the space 10, mixed with some air, after having lubricated some mechanisms; the air escapes through the vent C, whereas fluid 11 should be removed through a duct 14 directed to the suction connection 2 or 2″ of the pump 1. In this case, the device 12 comprises a float 12′ installed and guided in the space 10 in order to follow the displacements of the level of fluid 11, and a shutter 12″ solid with float 12′ and intended to close the opening of duct 14 in the space 10, when the float 12′ reaches a lower position corresponding to the minimum prefixed level of fluid 11 in the space 10. When, on the contrary, the level of fluid 11 overcomes said minimum level, float 12′ rises along with the shutter 12″, and fluid 11 is sucked by pump 1 through the duct 14.

According to FIG. 4, also in this case the space 10 has inlets A and B through which arrives the second fluid 11, which may be mixed with another fluid 13 intended to escape through a vent C. In this case, the duct 15 directed to the suction connection 2 or 2″ of the pump 1 arrives from above and plunges up near the bottom of space 10. The device 12 still comprises a float 12′ installed and guided in the space 10 in order to follow the displacements of the level of fluid 11, and it has a solid valve 12° cooperating with openings 15° of the duct 15 in order to close the same when the float takes a lower position corresponding to the minimum prefixed level of fluid 11 in the space 10, whereas it leaves free said openings when the level of fluid 11 overcomes said minimum level, whereby the fluid 11 is then sucked by the pump 1 through the duct 15.

According to FIG. 5, also in this case the space 10 has inlets A and B through which arrives the second fluid 11, which may be mixed with another fluid 13 intended to escape through a vent C. In this case, in the duct 16 directed to the suction connection 2 or 2″ of the pump 1 is interposed an electrovalve 17 being a part of the device 12. This device also comprises two detectors 18 and 19 which detect the minimum level and, respectively, the maximum level which have been pre-established for the fluid 11, and comprises a processing means controlled by said detectors 18 and 19, which in turn controls the electrovalve 17, intercepting the duct 16 when the fluid 11 reaches the prefixed minimum level and leaving free the passage when the level of fluid 11 overcomes the prefixed maximum level, whereby the fluid 11 is then sucked by the pump 1 through the duct 16.

The above is referred to the most frequent case in which the second fluid to be removed is the fluid occupying the lower portion of the second space. In special cases, however, it may be required that the second fluid to be removed be the fluid occupying the upper portion of the second space, for example in order to remove air from said space. In such a case the described arrangements are to be inverted, and the passage for the suction of the second fluid will be opened by the lowering of a float or by the corresponding behavior of a device such as that according to FIG. 5.

Therefore, in the specific and preferred automotive application, this invention allows a noticeable saving in the cost of the vehicle component parts, because the only existing vacuum pump accomplishes both its usual function, consisting in sucking air, and the additional function of sucking oil. Thus, instead of two different component parts it is possible to use a single component part. Of course, it also ensues an advantage in terms of encumbrance. The system also offers advantages in terms of the total mass of the engine and therefore of the vehicle, also affording a certain advantage in terms of fuel consumption. Moreover the system also offers advantages in terms of energy consumption, and therefore of fuel consumption, with reference to the energy absorbed for the rotation of the vacuum pump, because the total energy consumption of the sole component is lesser than the consumption of two components which should have been simultaneously installed on the engine. Finally, it is an advantage of the invention the optimization of the oil quantity really in circle in the system, thanks to the removal of the oil masses stagnating in tanks or cavities.

Corresponding results and advantages are obtained in different applications of this invention.

It is to be understood that this invention is not limited to the embodiments which have been described and shown as examples. Several modifications have been stated in the description, and others are available to those skilled in the art. These modifications and others, as well as any replacement by technically equivalent means, may be applied to what has been described and shown, without departing from the scope of this invention as defined by the appended Claims.

1. A suction system comprising a suction pump (1) having at least one suction connection (2,2′,2″) and a delivery connection (3), a receiving reservoir (4) connected to said delivery connection (3), connecting pipings from a suction connection (2,2′) to a first space (7) from which a first fluid (8) should be sucked, and connecting pipings from said delivery connection (3) to said receiving reservoir (4), characterized in that the system further comprises a connecting piping (14,15,16), extending from a second space (10) from which a second fluid (11) should be sucked, to said at least one suction connection (2,2′,2″) of the pump (1), and comprises a device (12) disposed for causing an intermittent operation of the second fluid suction by the pump (1), responsive to the level reached by the fluid (11) in said second space (10).

2. A suction system as set forth in claim 1, characterized in that said pump (1) is a vacuum pump, said first fluid (8) is air, said first space (7) is a depressurized reservoir, said second fluid (11) is oil and said second space (10) is a space wherein oil (11) has a tendency to accumulate.

3. A suction system as set forth in claim 1, characterized in that said pump (1) being a part of the system is of the kind having two suction connections (2′,2″), a first suction connection (2′) of the pump (1) is connected to said first space (7) for sucking therefrom said first fluid (8), and the second suction connection (2″) of the pump (1) is connected to said second space (10) for sucking therefrom said second fluid (11).

4. A suction system as set forth in claim 1, characterized in that said device (12) disposed for causing an intermittent operation of the pump (1) in sucking said second fluid (11) responsive to the level reached by a fluid (11) in said second space (10) comprises a means (12′,18, 19) for measuring the level reached by said second fluid (11) in said second space (10), an interception means (12″,12°,17) interposed in said connection (14,15,16) from said second space (10) to said at least one suction connection (2,2″) of the pump (1), and means (12,20) for activating said interception means (12) when said level of the second fluid (11) comes down a pre-established minimum level, and for inactivating said interception means (12) when said level of the second fluid (11) overcomes a pre-established maximum level.

5. A suction system as set forth in claim 4, characterized in that said connection (14,15) from said second space (11) to said at least one suction connection (2,2″) of the pump (1) opens near the bottom of said second space (10), and inside said second space (10), in the bottom portion thereof, is installed a device (12) provided with a float (12′), which closes the opening of said connection (14,15,16), thus intercepting the suction of the second fluid (11) by the pump (1), when the float (12′), along with the second fluid (11), reaches the pre-established minimum level.

6. A suction system as set forth in claim 4, characterized in that said connection (14,15) can arrive to its opening near the bottom of said second space (10) either coming from below or coming from above and plunging into said second space (10).

7. A suction system as set forth in claim 4, characterized in that said means (18,19) for measuring the level reached by said second fluid (11) in said second space (10) comprises means (18,19) for revealing the level of said second fluid (11), installed in said second space (11) at different levels, said interception means (17) is interposed in said connection (16) outside said second space (11), and said means (20) for activating and inactivating said interception means (12) are controlled by said means (18,19) for revealing the level of said second fluid (11).

8. A suction system as set forth in claim 4, characterized in that said interception means (17) is embodied by an electromagnetically controlled valve (electrovalve 17), intended for intermittently opening the passageway from said second space (11) to said pump (1).
